(19) United States
(12) Patent Application Publication
(10) Pub. No.: US 2010/0295637 A1
(43) Pub. Date: Nov. 25, 2010

(54) Coaxial Attenuator and Method of Manufacture

(76) Inventors: Hatem Aead, West Paterson, NJ (US); Ronald Joseph Vecchio, Morris Plans, NJ (US); Mark Alan Imbimbo, Butler, NJ (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/468,453

(22) Filed: May 19, 2009

(51) Int. Cl. H01P 1/22; H01P 11/00

(52) U.S. Cl. 333/81 A; 29/592.1

(57) ABSTRACT

A coaxial attenuator is provided. The attenuator includes a central body with first and second sockets at opposite ends thereof, outer conductors threadably engageable with the first and second sockets, inner conductors coaxial with the outer conductors, a resistive element or “chip” positioned within the central body, and a floating shroud or jack adapter captured between the central body and one of the outer conductors. Transverse slots are formed in ends of the inner conductors to create flexible ends which contact and bias sides of the resistive element. The floating shroud includes an internal, annular projection which is captured between a shoulder formed in the outer conductor and a side of the central body, allowing the shroud to be captured on the attenuator while permitting movement of the shroud with respect to the central body and the outer conductor.

### BACKGROUND OF THE INVENTION

1. Field of the Invention

The present invention relates to a coaxial attenuator.

2. Related Art

An attenuator is a resistive electrical device which reduces the power (usually expressed in decibels or “dB”) of an electrical signal. Often, attenuators are used with radio-frequency (RF) equipment to reduce the power level of RF signals to a desired level. Attenuators operate at specific frequencies, and can be fixed (i.e., the attenuator provides fixed attenuation levels across a desired frequency range) or variable (i.e., the attenuator can be adjusted to provide varying attenuation levels across a desired frequency range).

Frequently, attenuators are coaxial in design, such that an inner conductor of the attenuator is positioned within (i.e., coaxial with) an outer conductor, and is insulated therefrom by a dielectric. Coaxial connectors are provided so that the attenuator can be connected “inline” between two devices (e.g., between an antenna and a receiver), or between coaxial cables connected to such devices. Additionally, a resistive element or “chip” is positioned within the attenuator body, and is connected between the outer (or, ground) conductor and the inner conductor, thereby providing an electrical resistance between the conductors which reduces the power level of an electrical signal passed through the attenuator.

It is known to use springs and associated components to contact and bias the sides of a chip in an attenuator, so that the chip is held in a fixed position within the attenuator. Such an arrangement also completes an electrical connection between the chip and the inner conductor of the attenuator. Unfortunately, such springs/components are difficult to assemble, are easily lost due to their small size, and additional materials and manufacturing processes are required for fabrication.

It is also known to provide a threaded “shroud” or jack adapter on one end of the attenuator, which can be rotated with respect to the attenuator body and threadably engaged with a complementary coaxial connector (e.g., a connector on a piece of RF equipment, or a connector of a coaxial cable). In one such design, a C-shaped clip is fit into a recess and used to capture the shroud on the attenuator. However, such a design is difficult to assemble, and is relatively expensive because it requires additional manufacturing steps and materials to produce.

### SUMMARY OF THE INVENTION

The present invention relates to a coaxial attenuator having a central body with first and second sockets at opposite ends thereof, outer conductors threadably engageable with the first and second sockets, inner conductors coaxial with the outer conductors, a resistive element or “chip” positioned within the central body, and a floating shroud or jack adapter captured between the central body and one of the outer conductors. One or more transverse slots are formed in ends of the inner conductors to create flexible ends which contact the resistive element, and which are compressed against sides of the resistive element when the outer conductors are threaded into the first and second sockets. The floating shroud includes an internal, annular projection which is captured between one of the outer conductors of the attenuator and the central body. One end of the outer conductor can be inserted through the shroud and can be threadably mated with one of the sockets of the central body, so that the annular projection is captured between a shoulder formed in the outer conductor and a side of the central body. This allows the shroud to be captured on the attenuator while permitting movement of the shoud (e.g., rotation, angulation, and translation) with respect to the central body and the outer conductor.

The present invention also relates to a method for manufacturing a coaxial attenuator. A central body having first and second sockets at ends thereof are formed, as well as first and second outer conductors and a shroud. First and second inner conductors with transverse slots forming flexible ends are then formed. The first and second inner conductors are inserted into first and second dielectric portions, and the first and second dielectric portions and the first and second inner conductors are inserted into the first and second outer conductors. An epoxy material is injected into the first and second outer conductors and the first and second dielectric portions, and allowed to cure so that the first and second outer conductors, the first and second dielectric portions, and the first and second inner conductors are bonded together. A resistive element is inserted into a nest formed in the central body, and the resistive element is soldered to the central body to create a ground connection between the resistive element and the outer conductors. One end of the first outer conductor is inserted through an aperture in the shroud, and the ends of the first and second outer conductors are threaded into the first and second sockets of the central body so that the flexible ends of the first and second inner conductors contact and bias sides of the resistive element, and so that the shroud is captured between the first outer conductor and the central body.

### BRIEF DESCRIPTION OF THE DRAWINGS

The foregoing features of the invention will be apparent from the following Detailed Description of the Invention, taken in connection with the accompanying drawings, in which:

FIG. 1 is a partial cross-sectional view showing the coaxial attenuator of the present invention;

FIGS. 2-4 are cross-sectional views showing construction of the coaxial attenuator of FIG. 1 in greater detail;

FIG. 5 is a perspective view showing construction of the coaxial attenuator of the present invention in greater detail;

FIG. 6 is an exploded view of the components shown in FIG. 5;

FIGS. 7-8 are cross-sectional views of the components shown in FIG. 5, taken along the lines 7-7 and 8-8 of FIG. 5, respectively; and

FIGS. 9-10 are graphs showing return loss and attenuation characteristics, respectively, of the coaxial attenuator of the present invention.

### DETAILED DESCRIPTION OF THE INVENTION

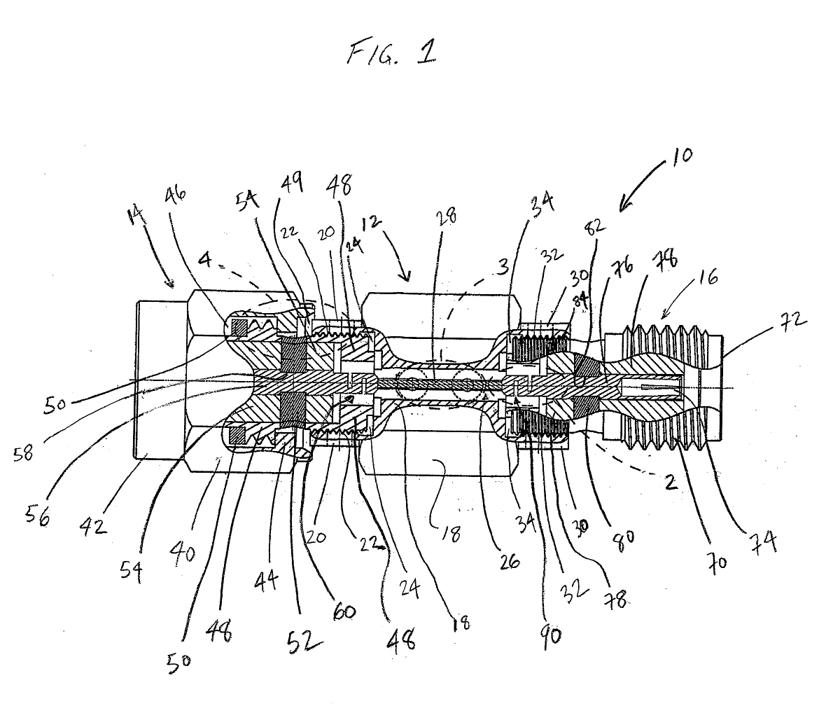

The present invention relates to a coaxial attenuator, as discussed in detail below in connection with FIGS. 1-10.

FIG. 1 is a cross-sectional view of the coaxial attenuator of the present invention, indicated generally at The attenuator 10 includes a central body 12, a floating shroud (or, jack adapter) 14 which is threadably attachable to a coaxial connector (e.g., a coaxial connector on a transceiver, amplifier, antenna, cable, etc.), and a jack 16 for connection to another piece of equipment or a cable. The central body 12 includes a housing 18 which houses and protects a resistive element 28 positioned therein, and first and second sockets 20, 30 on opposite sides of the housing 18. The first socket 20 includes internal threads 22 which receive a first threaded outer conductor 48. A recess 24 is provided in the housing 18 for receiving the outer conductor 48. A central space or “nest” 26 is provided in the housing 18 for receiving the resistive element 28. The second socket 30 includes internal threads 32 for receiving a second threaded outer conductor 84 of the jack 16. A recess 34 is also provided in the housing 18 for receiving the outer conductor 84. When the outer conductors 48, 84 are threaded into the respective sockets 20, 30, a complete electrical path is formed between the outer conductors 48, 84 and the central body 12 (including the housing 18). Such electrical path provides the “ground” electrical path for the attenuator 10.

It is noted that the attenuator 10 could be provided with two jacks, or two shrouds, or any combination thereof, by simply threading such components into the first and second sockets 20, 30, as desired. Also, the shapes and configurations of such components could conform to any suitable, coaxial connector standards, such as types C, F, N, BNC, TNC, PL-259, SO-239, 7/16 DIN, SMA, 2.44 mm, etc., without departing from the spirit or scope of the present invention.

The shroud 14 includes a “nut” region 40 having two or more wrench flats (e.g., the nut region 40 could be hexagonal in shape, as is common with some screw-in coaxial connectors), a rounded, recessed portion 42 at one end of the shroud 14, and an annular projection 44 at an opposite end of the shroud 14. The annular projection 44 is captured within an annular recess 49 which is formed when one end of the outer conductor 48 is threaded into the first socket 20, so that the shroud 14 is captured on the attenuator 10 but moves freely with respect to the attenuator 10 (i.e., the shroud 14 can rotate, pivot, and translate with respect to the central body 12 and the outer conductor 48). An inner region 46 is provided in the shroud 14 to accept a coaxial connector. The outer conductor 48, which could be threaded at both ends, provides a first (ground) electrical connection for the attenuator 10 when the shroud 14 is threaded onto and tightened against a complementary coaxial connector of a piece of equipment, or a cable. Optionally, a disk 50 could be provided at one end of the outer conductor 48.

A dielectric portion 54 surrounds an inner conductor 56, which provides a second electrical connection for the attenuator when the shroud 14 is threaded onto and tightened against a complementary coaxial connector of a piece of equipment, or a cable. The dielectric portion 54 insulates the inner conductor 56 from the outer conductor 48. An epoxy material 52 is injected into a recess in the dielectric portion 54, and, when cured, bonds the outer conductor 48, the dielectric portion 54, and the inner conductor 56 together to form a tight mechanical connection between these parts. The inner conductor 56 includes a recessed portion 58 at the area of bonding with the epoxy material 52 so as to retain the inner conductor 56 in a fixed position within the dielectric portion 54. The opposite end of the inner conductor includes a flexible end 60 formed by one or more transverse slots in the inner conductor 56, which provide spring-like flexibility and allow the inner conductor 56 to be biased against one end of the resistive element 28 when the outer conductor 48 is threaded into the first socket 20 of the central body 12.

The jack 16 includes an outer conductor 84 having a threaded outer end 70, a socket portion 72, and a recess 74. The jack 16 receives a second coaxial connector (e.g., a connector attached to an end of a coaxial cable), which can be threadably connected thereto, such that the outer conductor 84 makes electrical contact with the outer (ground) conductor of such a connector when the connector is threaded onto the threaded outer end 70 of the jack 16. The recess 74 receives and makes electrical contact with an inner conductor of the second coaxial connector/cable, and is formed in one end of an inner conductor 76 of the connector 16. The inner conductor 76 extends through an aperture formed in a dielectric portion 78, which insulates the inner conductor 76 from the outer conductor 84. An epoxy material 80 is injected into a recess in the dielectric portion 78, and, when cured, glues the outer conductor 84, the dielectric portion 78, and the inner conductor 76 together to form a tight mechanical connection between these parts. The inner conductor 76 includes a recessed portion 82 at the area of bonding with the epoxy material 80 so as to retain the inner conductor 76 in a fixed position within the dielectric portion 78. The opposite end of the inner conductor 76 includes a flexible end 90 formed by one or more transverse slots in the inner conductor 76, which provides spring-like flexibility and allows the inner conductor 76 to be biased against one end of the resistive element 28 when the outer conductor 84 is threaded into the socket 30 of the central body 12.

The central body 12, shroud 14, outer conductors 48, 84, and inner conductors 56, 76 could be formed from any suitable, electrically-conductive, metallic materials, such as brass, copper, stainless steel, gold, silver, aluminum, or any other suitable materials. Additionally, the dielectric portions 54, 78 could be formed form TEFLON®, plastic, or any other suitable dielectric material. Also, the epoxy materials 52, 80 could be substituted with any suitable adhesive material, as well as a rubber material which frictionally engages components of the attenuator 10 to hold such components together.

FIG. 2 is a cross-sectional view showing construction of the attenuator 10 of FIG. 1 in greater detail. The inner conductor 76 includes a contact end 92 which contacts and is biased against an edge 36 of the resistive element 28. One or more transverse slots 94 permit the flexible end 90 of the inner conductor 76 to be compressed, and provide spring-like flexibility. Construction of the flexible end 60 of the inner conductor 56 shown in FIG. 1 is identical to the construction of the flexible end 90 of the inner conductor 76.

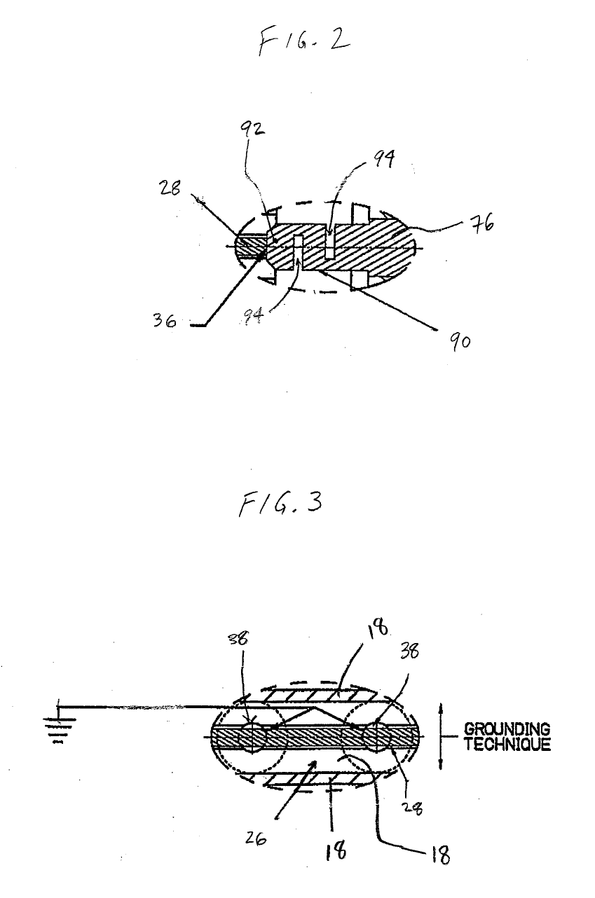

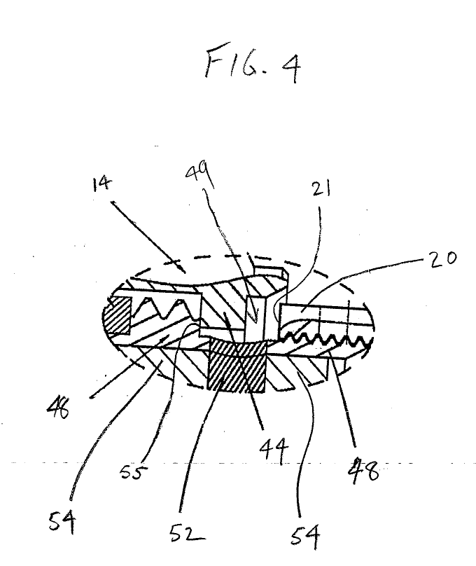

FIG. 3 is a cross-sectional view showing the resistive element 28 and nest 26 of FIG. 1 in greater detail. As mentioned above, the resistive element 28 is positioned within the nest 26, which houses and protects the resistive element 28. Solder connections 38 are provided between the resistive element 28 and the housing 18, which is in electrical connection with the outer conductors 48 and 84. The outer conductors 48 and 84 are at ground potential, and the solder connections 38 thus provide a path to ground for the resistive element 28.

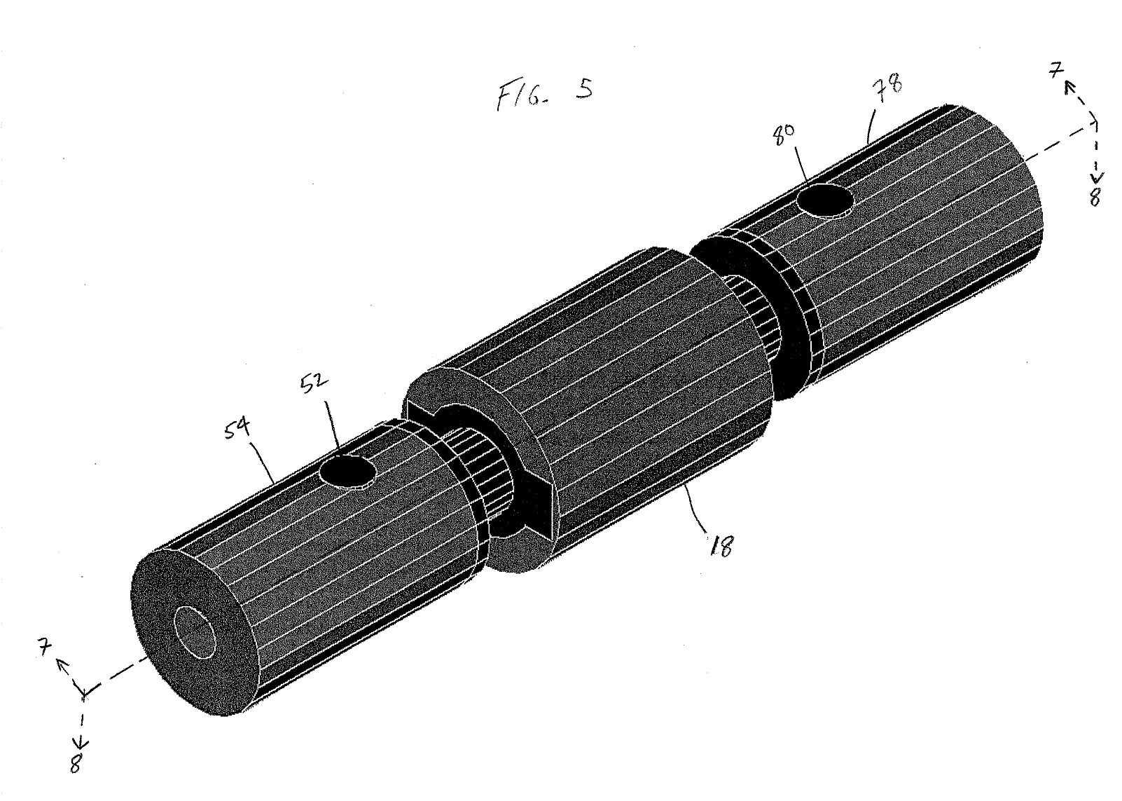

FIG. 4 is a cross-sectional view showing capturing of the shroud 14 of FIG. 1 in greater detail. When the outer conductor 48 is threaded into the socket 20, an annular recess 49 is created, such that the annular projection 44 is captured between a shoulder 55 of the outer conductor 48 and a side 21 of the socket 20. This arrangement permits motion (i.e., rotation, translation, and angulation) of the shroud 14, and obviates the need for a “C” clip as is used in conventional attenuators to retain the shrouds thereof. Accordingly, this reduces component count and results in simple assembly.

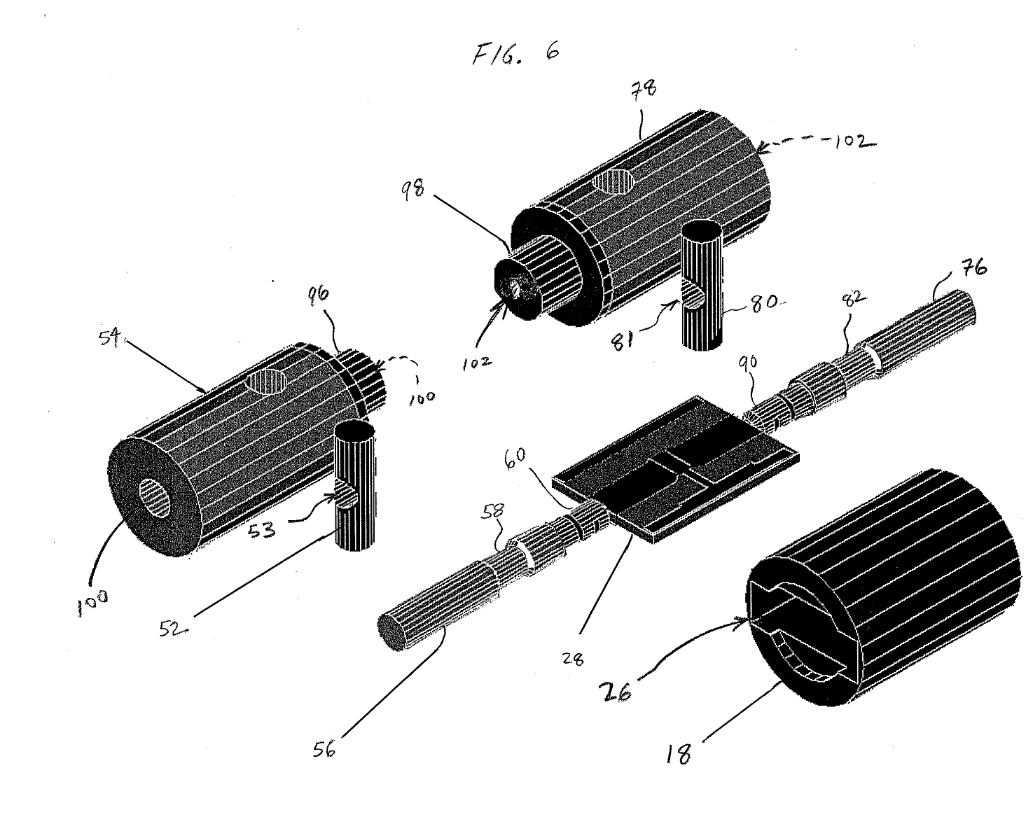

FIG. 5 is a perspective view showing construction of the attenuator of the present invention in greater detail. As can be seen in FIG. 5, the dielectric portions 54, 78 and the nest 26 can be cylindrical in shape. The epoxy materials 52, 80 extend through apertures formed in the dielectric portions 54, 78. The resistive element 28 and inner conductors 56, 76 of FIG. 1 (not shown in FIG. 5) are positioned within the housing 18 and the dielectric portions 54, 78, respectively.

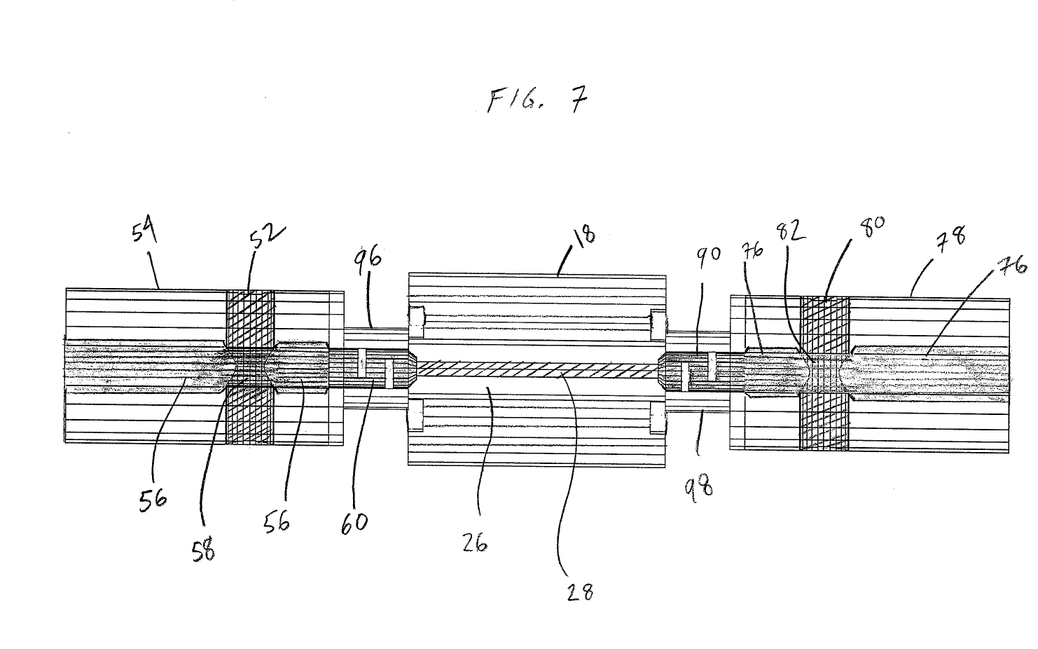

FIG. 6 is an exploded view of the components shown in FIG. 5. The dielectric portion 54 includes an aperture 100 which receives the inner conductor 56. Optionally, the dielectric portion 54 could include a stepped portion 96, as shown in FIG. 6. If the stepped portion 96 is not provided, empty space serves as a dielectric in place of the stepped portion 96 (i.e., as shown in FIG. 1). The epoxy material 52 includes an aperture 53 which receives the recessed portion 58 of the inner conductor 56. Similarly, the dielectric portion 78 includes an aperture 102 which receives the inner conductor 76. Optionally, the dielectric portion 78 could include a stepped portion 98, as shown in FIG. 6. If the stepped portion 98 is not provided, empty space serves as a dielectric in place of the stepped portion 98 (i.e., as shown in FIG. 1). The epoxy material 80 includes an aperture 81 which receives the recessed portion 82 of the inner conductor 76. The flexible ends 60, 90 contact and are biased against the resistive element 28, and electrically connect the resistive element 28 to the inner conductors 56, 76. The nest 26 extends along the length of the housing 18, and receives the resistive element 28.

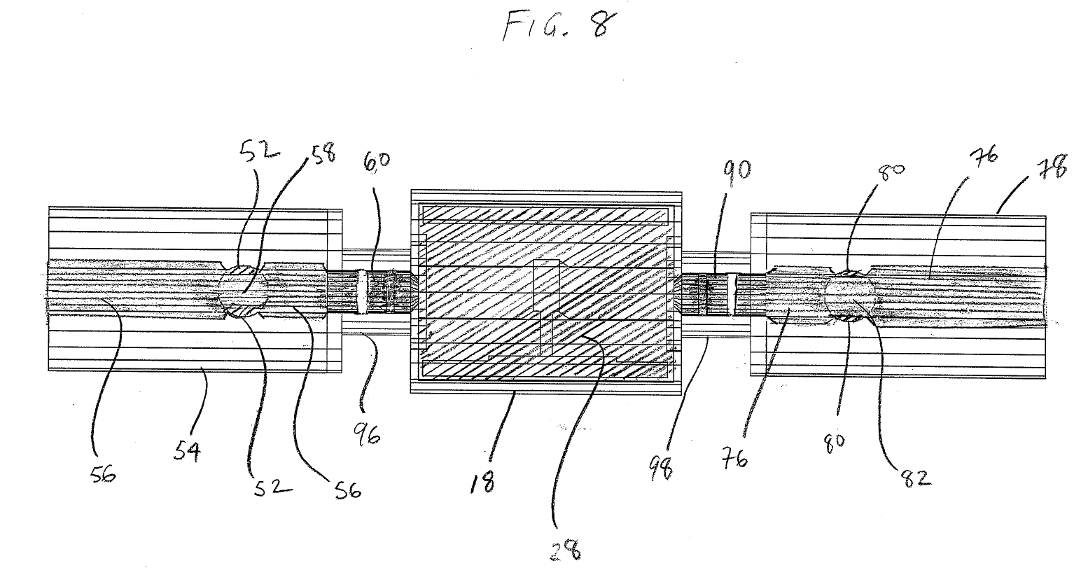

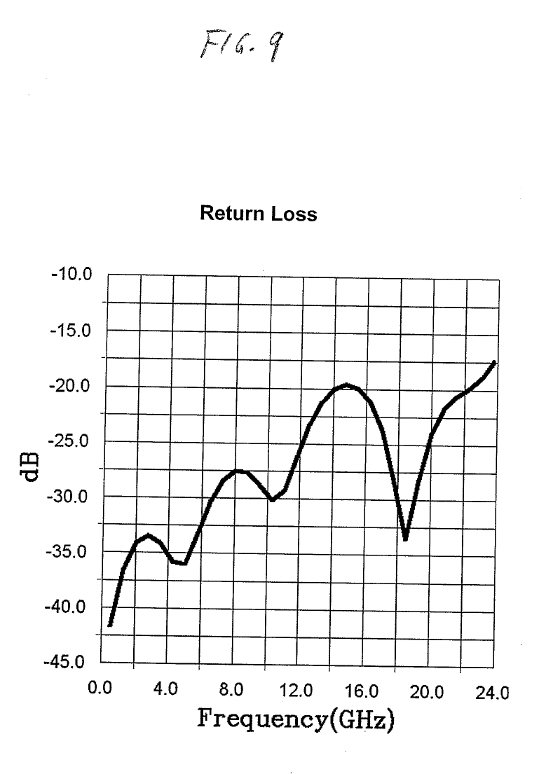

FIGS. 7-8 are cross-sectional views of the components shown in FIG. 5 and taken along the lines 7-7 and 8-8 of FIG. 5, respectively. As can be seen in these views, the epoxy materials 52, 80 retain the inner conductors 56, 76 in fixed positions within the dielectric portions 54, 78. Also, as can be seen in FIGS. 7-8, the flexible ends 60, 90 of the inner conductors 56, 76 contact and are biased against the resistive element 28.

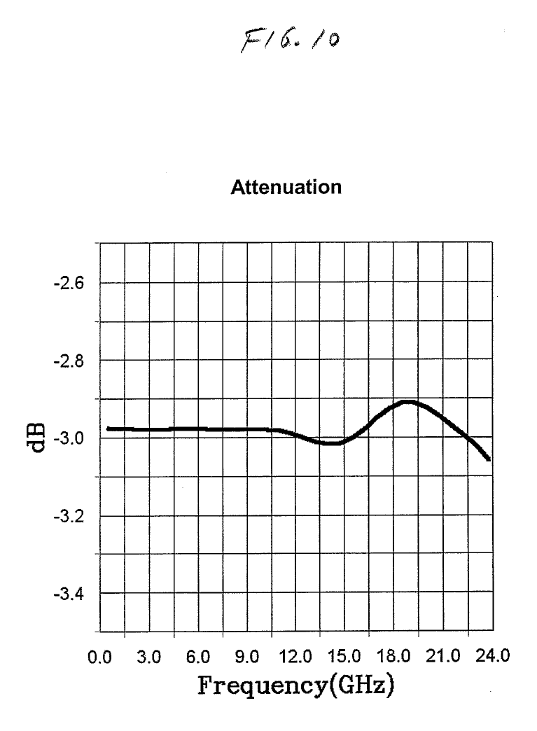

FIGS. 9-10 are graphs showing return loss and attenuation characteristics, respectively, of the coaxial attenuator of the present invention. As can be seen in FIG. 9, return losses peak at approximately −17.5 dB at a frequency of 24 GHz, and are lowest at frequencies below 2 GHz. As shown in FIG. 10, the attenuation levels peak at approximately −2.9 dB at an operating frequency of about 20 GHz, and begin to drop off at about 24 GHz. The coaxial attenuator of the present invention can effectively operate at frequency ranges of 2-24 GHz and power levels of less than −40 dB to greater than −17 dB, but these parameters can be varied by altering the physical dimensions and/or materials of the coaxial attenuator, as desired.

The coaxial attenuator 10 of the present invention can be manufactured as follows. First, the dielectric portions 54, 78 are formed, and are drilled to create longitudinal and transverse apertures for receiving the inner conductors and the epoxy materials, respectively. Then, the inner conductors 56, 76 are milled to a desired shape, and the recessed portions 58, 82 are milled in the inner conductors 56, 76. The flexible ends 60, 90 are then formed by cutting slots into the inner conductors 56, 76. Then, the inner conductors 56, 76 are inserted through the apertures of the dielectric portions 54, 78.

The outer conductors 48, 84, the central body 12 (including the housing 18, sockets 20-30, and the nest 26), and the shroud 14 are milled to the shapes disclosed herein using conventional milling techniques. Transverse apertures are drilled in the outer conductors 48, 84 for accepting epoxy. Then, the insert assemblies discussed above (i.e., the inner conductors 56, 76 and the dielectric portions 54, 78) are inserted into the outer conductors 48, 84 so that the transverse apertures thereof are aligned with each other. Once aligned, the epoxy materials 52, 80 are injected into the transverse apertures of the outer conductors 48, 84 and the dielectric portions 54, 78. The epoxy materials 52, 80 are then left to cure to form completed outer and inner conductor assemblies.

The resistive element 28 is located within the nest 26 of the housing 18 of the central body 12, and the resistive element 28 is soldered to the housing 18. Then, one end of the outer conductor 48, as well as the dielectric portion 54 and the inner conductor 56 bonded thereto, are inserted through an aperture in the shroud 14, and the outer conductor 48 is threaded into the sockets in the central body so that the annular projection 44 of the shroud is captured between the shoulder 55 of the outer conductor 48 and the side 21 of the central body 12. Finally, the outer conductor 84 is threaded into the second socket 30 of the central body 12, forming a complete coaxial attenuator. When the outer conductors are tightened into the first and second sockets, the flexible ends 60, 90 of the inner conductors contact the resistive element 28 and bias same to maintain contact. Of course, it is noted that the manufacturing steps disclosed herein could be varied as desired without departing from the spirit or scope of the present invention.

Having thus described the invention in detail, it is to be understood that the foregoing description is not intended to limit the spirit or scope thereof. What is desired to be protected is set forth in the following claims.

What is claimed is:

1. A coaxial attenuator, comprising:
a central body having first and second sockets on opposite ends thereof;
first and second outer conductors engageable with the first and second sockets;
first and second inner conductors coaxial with the first and second outer conductors;
first and second flexible ends formed in the first and second inner conductors; and
a resistive element positioned within the central body and biased by the first and second flexible ends of the first and second inner conductors.

2. The attenuator of claim 1, wherein the first and second flexible ends are formed by one or more transverse slots formed in the first and second conductors.

3. The attenuator of claim 2, wherein the first and second flexible ends contact sides of the resistive element and provide electrical connections between the resistive element and the first and second inner conductors.

4. The attenuator of claim 1, further comprising first and second dielectric portions between the first and second inner conductors and the first and second outer conductors.

5. The attenuator of claim 4, further comprising first and second epoxy materials for interconnecting the first and second outer conductors, the first and second inner conductors, and the first and second dielectric portions.

6. The attenuator of claim 5, wherein the first and second epoxy materials are injected into apertures formed in the first and second outer conductors and the first and second dielectric portions.

7. The attenuator of claim 6, wherein the first and second inner conductors include recessed portions for contacting the first and second epoxy materials.

8. The attenuator of claim 1, further comprising a floating shroud captured between the first outer conductor and the first socket.

9. The attenuator of claim 8, wherein the floating shroud includes an annular projection between a shoulder of the first outer conductor and a side of the first socket when the first outer conductor is threaded into the first socket.

10. The attenuator of claim 9, wherein a portion of the first outer conductor extends through the floating shroud.

11. The attenuator of claim 1, wherein the central body includes a nest for receiving the resistive element.

12. The attenuator of claim 1, wherein the first and second outer conductors are threadably engageable with the first and second sockets.

13. The attenuator of claim 1, further comprising solder connections for electrically connecting the resistive element to the first and second outer conductors of the attenuator.

14. A method for manufacturing a coaxial attenuator, comprising the steps of:
forming an central body having first and second sockets at ends thereof, first and second outer conductors, and a shroud;
forming first and second inner conductors with flexible ends;
inserting the first and second inner conductors into first and second dielectric portions;
inserting the first and second dielectric portions and the first and second inner conductors into the first and second outer conductors;
injecting an epoxy material into the first and second outer conductors and the first and second dielectric portions;
allowing the epoxy material to cure so that the first and second outer conductors, the first and second dielectric portions, and the first and second inner conductors are bonded together;
inserting a resistive element into the central body;
inserting an end of the first outer conductor through an aperture in the shroud; and
threadably engaging ends of the first and second outer conductors into the first and second sockets of the central body so that the flexible ends of the first and second inner conductors contact and bias sides of the resistive element to maintain contact with the resistive element.

15. The method of claim 14, further comprising forming the flexible ends in the first and second inner conductors by cutting transverse slots in ends of the first and second inner conductors.

16. The method of claim 14, further comprising forming recessed portions in the first and second inner conductors prior to inserting the first and second inner conductors into the first and second dielectric portions.

17. The method of claim 14, further comprising drilling longitudinal and transverse apertures in the first and second dielectric portions prior to inserting the first and second inner conductors into the first and second dielectric portions.

18. The method of claim 17, further comprising drilling transverse apertures in the first and second outer conductors prior to inserting the first and second inner conductors and the first and second dielectric portions into the first and second outer conductors.

19. The method of claim 18, further comprising aligning the transverse apertures of the first and second outer conductors and the first and second dielectric portions prior to injecting the epoxy material.

20. The method of claim 19, wherein the step of injecting the epoxy material comprises injecting the epoxy material into the apertures of the first and second outer conductors and the first and second dielectric portions.
